(19) United States
(12) Patent Application Publication
(10) Pub. No.: US 2018/0213765 A1
(43) Pub. Date: Aug. 2, 2018

(54) INSECT ATTRACTION THROUGH SPATIAL PARTITIONING OF ATTRACTANTS

(71) Applicant: APEX BAIT TECHNOLOGIES, INC., Santa Clara, CA (US)

(72) Inventor: Dangsheng Liang, Santa Clara, CA (US)

(73) Assignee: Apex Bait Technologies, Inc., Santa Clara, CA (US)

(21) Appl. No.: 15/748,400

(22) PCT Filed: Jul. 26, 2016
(86) PCT No.: PCT/US2016/044016

§ 371 Date: Jan. 29, 2018

Related U.S. Application Data
(60) Provisional application No. 62/198,298, filed on Jul. 29, 2015.

(51) Int. Cl. A01M 1/20; A01M 1/02; A01M 1/10

(52) U.S. Cl. CPC A01M 1/2016; A01M 1/106; A01M 1/023

(57) ABSTRACT

An insect attracting station comprising a housing, a first attractant, and a second attractant. The housing at least in part defines an insect-receiving chamber. The housing is adapted and configured to permit ingress of insects into the insect-receiving chamber. The first attractant is positioned external to the insect-receiving chamber. The first attractant is adapted to lure insects toward the insect-receiving chamber. The housing and the 18 second attractant are adapted and configured such that the second attractant emits an odor from the insect-receiving chamber to lure insects from outside of the insect-receiving chamber to within the insect-receiving chamber. The second attractant is different from the first attractant.

### CROSS-REFERENCE TO RELATED PATENT APPLICATIONS

This application claims the benefit of U.S. Provisional Patent Application No. 62/198,298, filed Jul. 29, 2015, which is incorporated herein by reference in its entirety.

### BACKGROUND

### Field of the Invention

The field of the invention pertains generally to insect attracting stations that provide for spatial partitioning of particular baits.

### SUMMARY

One aspect of the present invention is an insect attracting station comprising a housing, a first attractant, and a second attractant. The housing at least in part defines an insect-receiving chamber. The housing is adapted and configured to permit ingress of insects into the insect-receiving chamber. The first attractant is positioned external to the insect-receiving chamber. The first attractant is adapted to lure insects toward the insect-receiving chamber. The housing and the second attractant are adapted and configured such that the second attractant emits an odor from the insect-receiving chamber to lure insects from outside of the insect-receiving chamber to within the insect-receiving chamber. The second attractant is different from the first attractant.

Another aspect of the present invention is a method of attracting insects into an insect-receiving chamber of a housing of an insect-attracting station. The method comprises causing a first attractant to emit an odor from the insect-attracting station and causing a second attractant to emit an odor from the insect-receiving chamber to lure insects from outside of the insect-receiving chamber to within the insect-receiving chamber. The first attractant is adapted to lure insects toward the insect-receiving chamber.

Yet another aspect of the present invention is a method of inducing a user to attract insects into an insect-receiving chamber of a housing of an insect-attracting station. The method comprises inducing a user to cause a first attractant to emit an odor from the insect-attracting station and to cause a second attractant to emit an odor from the insect-receiving chamber to lure insects from outside of the insect-receiving chamber to within the insect-receiving chamber. The first attractant is adapted to lure insects toward the insect-receiving chamber.

Another aspect of the present invention is a method of attracting insects into an insect-receiving chamber of a housing of an insect-attracting station. The method comprises causing a first attractant to emit an odor and causing a second attractant to emit an odor from the insect-receiving chamber to lure insects from outside of the insect-receiving chamber to within the insect-receiving chamber. The first attractant is adapted and positioned to lure insects toward the insect-receiving chamber.

### BRIEF DESCRIPTION OF THE DRAWINGS/FIGURES

FIG. 1 is a perspective view of an embodiment of an insect attracting station of the present invention.

FIG. 2 is the perspective view of FIG. 1 with a portion broken away to show an insect-receiving chamber.

FIG. 3 is a perspective view of another embodiment of an insect attracting station of the present invention.

FIG. 4 is a perspective view of FIG. 3 with portions broken away to show an insect-receiving chamber and a second chamber.

FIG. 5 is the perspective view of another embodiment of an insect attracting station of the present invention with a portion broken away to show an insect-receiving chamber.

FIG. 6 is a perspective view of another embodiment of an insect attracting station of the present invention.

FIG. 7 is a cross-sectional view of the insect attracting station of FIG. 6.

FIG. 8 is another embodiment of an insect attracting station of the present invention with a portion broken away to show an insect-receiving chamber.

Reference numerals in the written specification and in the drawing figures indicate corresponding items.

### DETAILED DESCRIPTION

Provided herein are insect attracting stations, methods of their use, and methods of their manufacture wherein a first and a second attractant are spatially partitioned. Spatial partitioning is achieved by having a first attractant positioned external to or spaced from the insect-receiving chamber of the station and by having a housing and the second attractant adapted and configured such that the second attractant emits an odor from the insect-receiving chamber to lure insects from outside of the insect-receiving chamber to within the insect-receiving chamber. In certain embodiments, the insect attracting stations provided herein have a higher rate of insect ingress into the insect-receiving chamber than if both the first and second attractants emitted odors from the insect-receiving chamber. In certain embodiments, the rate of ingress for the insect attracting stations and associated methods provided herein is increased by at least 2-, 3-, 4-, 5-, 8-, or 10-fold in comparison to a station wherein both the first and second attractants emitted odors from the insect-receiving chamber. In certain embodiments, such rates of ingress are reflected in increased numbers of insects attracted into the insect-receiving chamber of the insect attracting stations provided herein over a given unit of time as compared to the numbers of insects attracted into the insect-receiving chamber of a station wherein both the first and second attractants emitted odors from the insect-receiving chamber over that same unit of time.

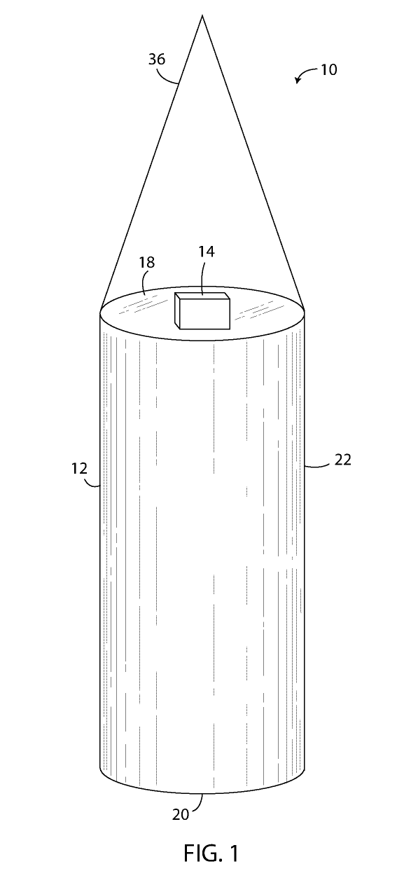

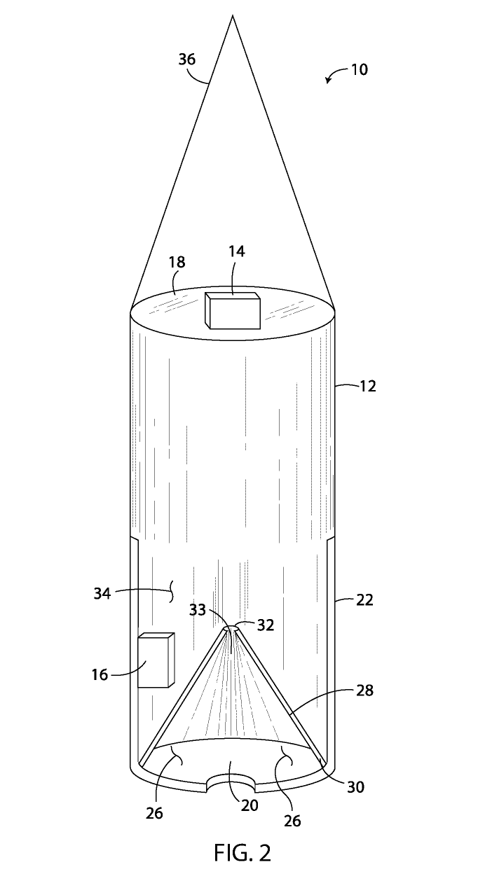

Illustrative and non-limiting embodiments of an insect attracting station having spatial partitioning of first and second attractants are described below in reference to FIGS. 1-8. An embodiment of an insect attracting station of the present invention is indicated generally by reference numeral 10 in FIGS. 1-2. In this embodiment, the insect attracting station 10 comprises a housing 12, a first attractant 14, and a second attractant 16.

In the embodiment shown in FIGS. 1-2, the housing 12 comprises a top 18, a bottom 20, and a wall portion 22. The wall portion 22 extends from the top 18 to the bottom 20. The housing 12 can be formed of any suitable material, including, but not limited to, polymers, glass, ceramic, wood, metal, and combinations thereof. Although the housing 12 is shown as being cylindrical-shaped in FIGS. 1-2, a person of ordinary skill in the art will understand that the housing could be a myriad of shapes, including, but not limited to, rectangular, cubed, spherical, pyramidal, and conical. In this embodiment, the top 18 and the wall portion 22 of the housing 12 are solid, and the bottom 20 comprises a plurality of entry openings 26. The entry openings 26 are adapted to enable an insect to pass therethrough. Although FIG. 2 shows three entry openings 26, a person of ordinary skill in the art will understand that the bottom 20 could have more than three entry openings or less than three entry openings.

As shown in FIG. 2, the housing 12 further comprises an insect-directing funnel 28. The funnel 28 may be cone-shaped or of any other suitable funnel shape. The funnel 28 is adjacent the bottom 20 and is surrounded by the wall portion 22. The funnel 28 is distinct from the bottom 20 and comprises a first end 30 and a second end 32. The first end 30 has a width that is substantially equivalent to the width of the bottom 20. The second end 32 has a width less than the width of the first end 30. The second end 32 comprises an opening 33 that is adapted to enable insects to pass therethrough. Collectively, the region bounded by the top 18, the wall portion 22, and the funnel 28 constitutes an insect-receiving chamber 34. The funnel 28 is adapted such that insects that have passed through the entry openings 26 of the housing 12 are funneled toward the insect-receiving chamber 34. Preferably, the second opening 32 of the funnel 28 is adapted to deter egress of insects from the insect-receiving chamber 34. It is to be understood that in certain embodiments of the present invention, the insect attracting stations traps insects within the insect-receiving chamber.

The insect attracting station 10 further comprises a hang line 36. The hang line 36 enables the insect attracting station 10 to be hung from a suitable location (e.g., a tree branch, a pole). The hang line 36 can be of any suitable material, including, but not limited to, metal, polymers, fibers (e.g., cotton), and combinations thereof.

In this embodiment, the first attractant 14 of the insect attracting station 10 is positioned adjacent an external surface of the top 18 of the housing 12. Accordingly, the first attractant 14 is external to the insect-receiving chamber 34. A person of ordinary skill in the art will understand that the first attractant 12 could be positioned on a different external surface of the housing 12. For example, the first attractant 12 could be positioned on an external surface of the wall portion 22. The first attractant 14 is adapted to lure insects toward the insect-receiving chamber 34. In certain embodiments, the first attractant 14 is adapted to lure insects from a region remote from the insect-receiving chamber 34 to a region adjacent the housing 12.

In this embodiment, the second attractant 16 of the insect attracting station 10 is positioned on an internal surface of the wall portion 22 of the housing 12. Accordingly, the second attractant 16 is positioned within the insect-receiving chamber 34. A person of ordinary skill in the art will understand that the first attractant 12 could be positioned on a different internal surface of the housing 12. For example, the first attractant 12 could be positioned on an internal surface of the top 18. The second attractant 16 is positioned such that it emits an odor from the insect-receiving chamber 34 to lure insects from outside of the insect-receiving chamber to within the insect-receiving chamber.

It is to be understood that a variety of combinations of first and second attractants can be used in the insect attracting stations and associated methods provided herein. In one embodiment, the first and second attractants are adapted to lure at least one insect species from the Orders Diptera, Hymenoptera, Coleoptera, or Lepidoptera. In an alternative embodiment, the first and second attractants are adapted to lure at least one of a yellow jacket, hornet, or wasp. In another alternative embodiment, the first and second attractants are adapted to lure wasp species in the genus Vespula. In yet another alternative embodiment, the first and second attractants, alone or in combination, are unable to attract mosquitos. In certain embodiments, the first attractant 14 comprises at least one component selected from the group consisting of heptyl butryrate, butyl butryrate, isobutanol, 2-methyl butanol, and 3-methyl butanol. In certain embodiments, the second attractant 16 comprises at least one component selected from the group consisting of acetic acid, fish, fish essence, a fish constituent, a fish decomposition product, meat, meat essence, a meat constituent, a meat decomposition product, and a meat extract. In certain embodiments, each of the first and second attractants is adapted to lure at least one of a yellow jacket, hornet, or wasp, the first attractant comprises at least one component selected from the group consisting of heptyl butryrate, butyl butryrate, isobutanol, 2-methyl butanol, and 3-methyl butanol, and wherein the second attractant comprises at least one component selected from the group consisting of acetic acid, fish, fish essence, a fish constituent, a fish decomposition product, meat, meat essence, a meat constituent, a meat decomposition product, and a meat extract. In certain aspects of the aforementioned embodiment, each of the first and second attractants is adapted to lure a wasp species in the genus Vespula. Illustrative and non-limiting examples of first and second attractants that can be used in the context of the insect attracting stations and methods provided herein are shown in Table 1.

TABLE 1
Illustrative first and second attractants for use in attracting certain insect types.

| | First | | |
|---|---|---|---|
| Species | attractant | Second attractant | Reference |
| Lepidoptera | | | |
| Indian Meal Moth, | (Z,E)-9,12- | (Z,E)-9,12- | Phillips, T. W. Proceedings of the |
| Plodia | tetradecadienyl | tetradecadienol) | 6th International Working |
| interpunctella | acetate | (ZETOL) | Conference on Stored-product |
| | (ZETA) | | Protection. Vol. 1. 1994. |
| Codling moth | Codlemone | Apple tree volatiles | Annu. Rev. Entomol. (2008), |
| | (pheromone) | | 53: 503-522. |
| Diptera | | | |
| Aedes, Culex | Carbon dioxide | Lactic acid, skin | Medical and Veterinary |
| mosquitoes | | odors | Entomology (1999), 13: 97-100. |
| Aedes aegypti | Carbon dioxide | Skin (foot) odors | Physiological Entomology |
| | | | (2014), 39(1): 60-68. |
| Hymenoptera | | | |
| Trissoleus baselis | (E)-2-decenal | n-nonadecane | Psyche, Vol. 2012, Article ID |
| (Scelionidae) | | | 651015, 11 pages |
| Diachasmimorpha | Acetaldehyde, | Para | Behavioral Ecology (2008), 19 |
| longicaudata | acetic acid, | ethylacetophenone | (3): 677-689. |
| (Braconidae) | acetophenone | | |
| Yellowjackets | heptyl | acetic acid, fish, | |
| (Vespula sp.), | butryrate, butyl | fish essence, a fish | |
| hornets, wasps | butryrate, | constituent, a fish | |
| | isobutanol, 2- | decomposition | |
| | methyl | product, meat, meat | |
| | butanol, and 3- | essence, a meat | |
| | methyl butanol | constituent, a meat | |
| | | decomposition | |
| | | product, and a meat | |
| | | extract | |
| Coleoptera | | | |
| Plum Curculio | Aggregation | Plum tree volatiles | Environmental Entomology |
| | pheromone, | | (2005), 34(4): 785-793. |
| | grandisoic acid | | |
| Rynchophorus | Pheromone: | N-pentanol | J. Natn. Scie. Coun. Sri. Lanka |
| ferrugeneous | ferrugineol | | (1995), (1995) 23(2): 81-86. |
| (Cucrulionidae) | | | |

In operation, the insect-attracting station 10 is placed in an environment having insects of the type to be attracted by the first and second attractants 14, 16. Environments having insects of the type to be attracted include both outdoor environments (e.g. yards, parks, picnic areas, and the like) and indoor environments (e.g. food preparation and processing areas, dining areas, storage areas, and the like). For example, the insect-attracting station 10 can be hung via the hanging line 36 from a tree branch, a pole, a ceiling, or any structure located within an environment having insects of the type to be attracted by the first and second attractants 14, 16. In certain aspects, the insect-attracting station 10 can be affixed to a tree branch, a pole, a ceiling, or any structure located within an environment having insects of the type to be attracted by the first and second attractants 14, 16 with a rod, an adhesive, or other type of attachment. The first attractant 14 located on the external surface of the top 18 of the housing 12 emits an odor from the insect-attracting station 10. The odor of the first attractant 14 lures insects toward the insect-receiving chamber 34. Without seeking to be limited by theory, it is believed that the first attractant 14 lures insects from a region remote from the insect-receiving chamber 34. The second attractant 16 located on the internal surface of the wall portion 22 of the housing 12 emits an odor from the insect-receiving chamber 34. The odor of the second attractant 16 is emitted from the insect-receiving chamber 34 via the entry openings 26 located at the bottom 20 of the housing 12. The odor from the second attractant 16 lures insects from outside of the insect-receiving chamber 34 to within the insect-receiving chamber. More specifically, the odor of the second attractant 16 being emitted from the insect-receiving chamber 34 lures insects through the entry openings 26. The funnel 28 then funnels the insects that have passed through the entry openings 26 toward the insect-receiving chamber 34. Ultimately, the insects pass into the insect-receiving chamber 34 via the opening 33 of the funnel 28. After the insects are located within the insect-receiving chamber 34, the second opening 32 of the funnel 28 deters the egress of the insects from the insect-receiving chamber. The funnel 28 deters egress because trapped insects tend to fly upward (negative geotaxis) and toward light (positive phototaxis). Because of this, they are very unlikely to either encounter or escape through the second opening 32 of the funnel 28.

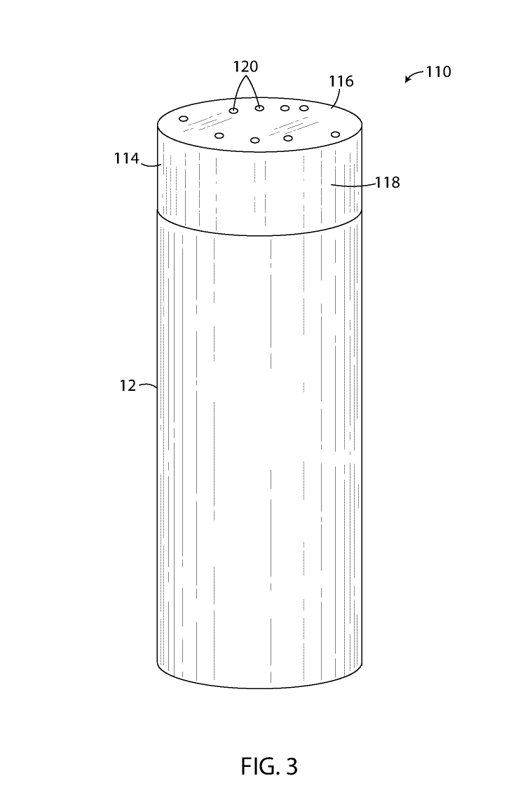

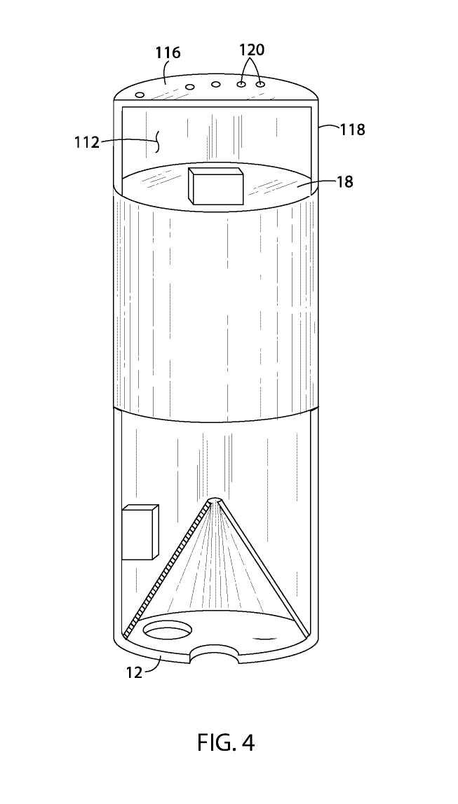

Another alternative embodiment of an insect-receiving station can be seen in FIGS. 3 and 4, and is indicated generally by reference numeral 110. The insect-receiving station 110 is similar in function and design to the insect-receiving station 10 shown in FIGS. 1 and 2 except for the differences noted within this paragraph. The insect-receiving station 110 comprises a second chamber 112 that is distinct from the insect-receiving chamber 34. The second chamber 112 is partially defined by a second housing 114 that includes an end wall 116 and a side wall 118. The second housing 114 is located adjacent the top 18 of the housing 12. As can be seen in FIG. 4, the second chamber 112 comprises the region bounded by the top 18 of the housing 12 and the end wall 116 and side wall 118 of the housing 114. As such, the second chamber 112 is separated from the insect-receiving chamber 34 by the top 18 of the housing 12. The first attractant 14 is located within the second chamber 112. The top 116 of the housing 114 contains a plurality of holes 120 adapted such that the odor of the first attractant is emitted from the second chamber.

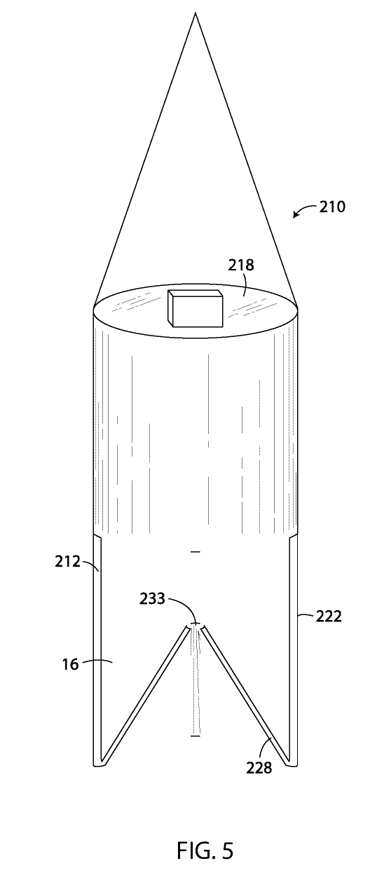

An alternative embodiment of an insect-receiving station is shown in FIG. 5 is indicated generally by reference numeral 210. The insect-receiving station 210 is similar in function and design to the insect-receiving station 10 shown in FIGS. 1-2 except for the differences noted within this paragraph. The insect-receiving station comprises a housing 212 having a top 218, a wall portion 222, and a funnel 228. The funnel 228 is formed integral with the wall portion 222. The funnel 228 comprises an opening 233 enabling insects to pass therethrough and enter the insect-receiving chamber 234. In operation, the odor of the second attractant 16 is emitted from the insect-receiving chamber 234 via the opening 233. The odor from the second attractant 16 lures insects from outside of the insect-receiving chamber 234 to within the insect-receiving chamber. More specifically, the odor of the second attractant 16 being emitted from the insect-receiving chamber 234 lures insects into a region of the funnel 228. The funnel 228 then funnels the insects toward the insect-receiving chamber 234. The insects enter the insect-receiving chamber 234 via the opening 233 of funnel 228.

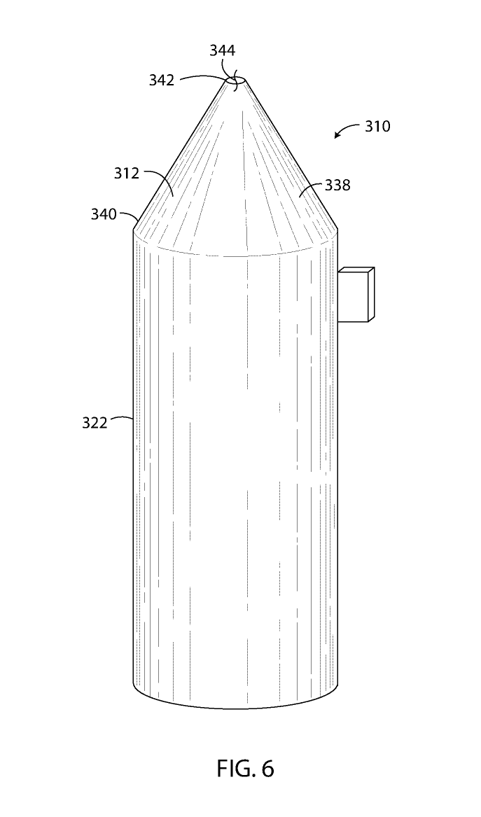

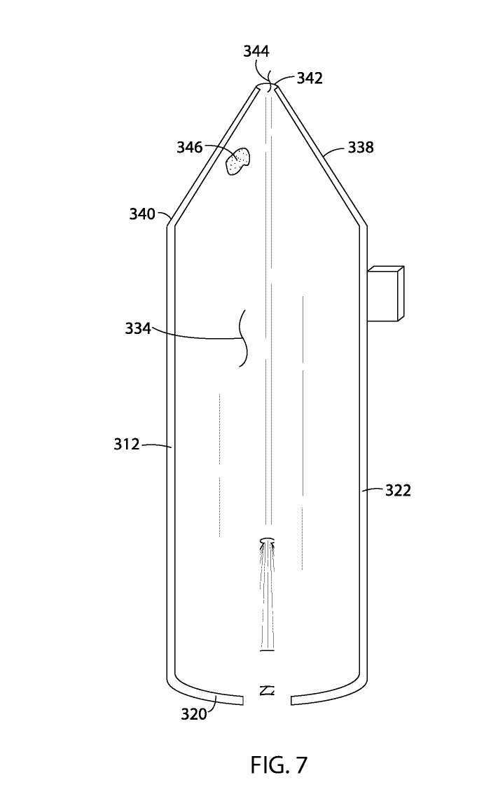

Yet another alternative embodiment of an insect-receiving station is shown in FIGS. 6-7 and is indicated generally by reference numeral 310. The insect-receiving station 310 is similar in function and design to the insect-receiving station 10 shown in FIGS. 1-2 except for the differences noted within this paragraph. The insect-receiving station 310 comprises a housing 312 having a bottom 320, a wall portion 322, a first funnel 328 and a second funnel 338. The region bounded by the first funnel 328, the wall portion 322, and the second funnel 338 constitutes the insect-receiving chamber 334. The second funnel 338 has a first end 340 and a second end 342. The second funnel 338 is formed integral with the wall portion 322 such that the first end 340 has a width that is substantially equivalent to the wall portion 322. The second end 342 has an opening 344. The second end 342 has a width that is less than the width of the first end 340. The second funnel 342 is adapted such that insects within the insect-receiving chamber 334 are funneled out of the insect-receiving chamber via opening 344. An internal surface of the second funnel 342 is coated with an insecticide 346. One of ordinary skill in the art will understand that the insecticide could also be coated on some or all of the other surfaces that define the insect-receiving chamber, such as an outer surface of the first funnel 328 or an internal surface of the wall portion 322. The insecticide 346 is configured to be contacted and transported away from the insect attracting station 310 via insects attracted into the insect-receiving chamber 334.

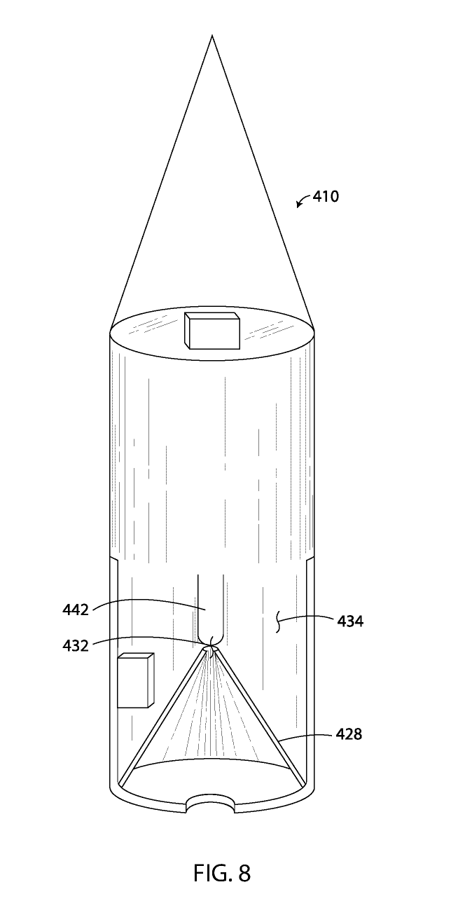

Yet another alternative embodiment of an insect-receiving station can be seen in FIG. 8 and is indicated generally by reference numeral 410. The insect-receiving station 410 is similar in function and design to the insect-receiving station 10 except for the differences noted within this paragraph. The insect-receiving station 410 comprises an element 442 adapted to destroy insects. The element 442 is located within the insect-receiving chamber 434 adjacent the opening 432 of funnel 428. In operation, insects will enter the insect-receiving chamber 434 via opening 432. The element 442 is oriented near the opening 432 in a manner such that at least some of the insects entering into the insect-receiving chamber 434 come into contact with a surface of the element. Upon contacting the surface of the element 442, an insect is destroyed. Such destruction can be immediate or delayed. Immediate destruction can be effected in certain embodiments where the element transmits electricity to the insect when contacted by the insect. Delayed destruction can occur in certain embodiments where the element comprises one or more insecticides. A person of ordinary skill in the art will understand that location of the element 442 within the insect-receiving chamber 434 could be adjusted. A person of ordinary skill in the art will also understand that additional elements could be utilized in conjunction the insect-receiving station 410.

In certain embodiments, an insect attracting station can comprise first and second attractants wherein the first attractant is detached from the insect-receiving chamber but positioned in proximity to the chamber and the second attractant emits an odor from an insect-receiving chamber. Moreover, in certain embodiments, the proximity of the first attractant to the chamber will be sufficient to allow for a higher rate of insect ingress into the insect-receiving chamber than if both the first and second attractants emitted odors from the insect-receiving chamber. In certain embodiments, the proximity of the first attractant to the chamber will be sufficient to allow for a higher rate of insect ingress into the insect-receiving chamber than if only the second attractant was provided and only the second attractant emitted odors from the insect-receiving chamber.

Inclusion of various references herein is not to be construed as any admission that such references represent art that in any way anticipates or suggests any of the embodiments presented herein.

As various modifications could be made in the constructions herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents. It should also be understood that the overall orientation of any of the above-described exemplary embodiments could be rotated when the insect attracting station is in use.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies.

### EXAMPLES

The following examples are included to demonstrate certain embodiments of the invention. It should be appreciated by those of skill in the art that the techniques disclosed in the examples which follow represent techniques discovered by the inventor to function well in the practice of the invention. However, those of skill in the art should, in light of the present disclosure, appreciate that many changes can be made in the specific embodiments which are disclosed and still obtain a like or similar result without departing from the spirit and scope of the invention.

### Example 1

### Side by Side Trap Experiments

Two traps were placed side by side, one containing chicken meat only while the other containing both chicken meat and heptyl butyrate (HB) in an enclosure containing Western Yellowjackets, Vespula pensylvanica. Amount of heptyl butyrate used per trap was several drops of 100% heptyl butyrate on a cotton ball estimated to be a volume of about 0.10 to 0.25 mL. Traps containing chicken meat alone captured more yellowjackets than those traps containing both chicken meat and heptyl butyrate. (Table 1). This was consistent with our preliminary finding of effective long range heptyl butrate attraction but an attraction that did not lead to greater trap catch. We observed, as previously reported, that heptyl butyrate is highly attractive to yellowjackets. Yellowjackets flew from a distance to visit the releasing point of heptyl butyrate. However, we observed that while yellowjackets attempted but failed to enter traps containing heptyl butyrate, they entered traps containing chicken meat readily without hesitation. In this experiment, yellowjackets were attracted from a long distance by the heptyl butyrate released from the trap. However, once the yellowjackets arrived in the vicinity of the traps containing either heptyl butyrate or chicken meat, they entered the traps containing only chicken meat. This suggested that heptyl butyrate was repelling yellowjackets from entering the traps containing chicken meat and heptyl butyrate.

TABLE 1
Comparison of trap captures of yellow jackets between traps
containing chicken meat only or traps containing both chicken meat
and heptyl butyrate where the traps were placed next to each other.
Rescue ® traps (Sterling International, Inc.,
Spokane, WA, USA) were used for this study.

| | 10 min | | 3 hrs | |
|---|---|---|---|---|
| | | Chicken Meat | | Chicken Meat |
| | Chicken | and Heptyl | Chicken | and Heptyl |
| | Meat Only | Butyrate | Meat Only | Butyrate |
| Site 1 | 3 | 1 | 34 | 11 |
| Site 2 | 3 | 1 | 32 | 2 |
| Site 3 | 3 | 0 | 28 | 3 |
| Site 4 | 3 | 3 | 40 | 6 |
| Site 5 | 3 | 1 | 40 | 2 |
| Site 6 | 0 | 4 | 12 | 17 |
| Site 7 | 2 | 1 | 55 | 12 |
| Total | 17 | 11 | 241 | 53 |

### Example 2

### Testing of Traps Containing Different Attractants and Combinations of Attractants

In another study, we placed 4 traps together, each containing a different attractant or combination of attractants. We found that again, while yellowjackets were attracted to the traps by heptyl butyrate, they more frequently entered traps containing chicken. Very few were captured by traps containing heptyl butyrate only. Even more surprising, addition of heptyl butyrate to the trap containing chicken caused a significant reduction in trap capture (Tables 2, 3, and 4). This clearly indicated that heptyl butyrate was repelling yellowjackets from entering the trap. This effect was not unique to any particular traps but was observed with traps of different design (Tables 2, 3, and 4).

TABLE 2
Comparison of trap captures of yellow jackets between traps
containing chicken meat and traps containing heptyl butyrate. Rescue ® traps
(Sterling International, Inc., Spokane, WA, USA) were used for this experiment.
All 4 traps were placed together.

| | 15 min | | | | 3 hrs | | | |
|---|---|---|---|---|---|---|---|---|
| | | | | Chicken | | | | Chicken |
| | | | | Meat | | | | Meat |
| | | | | and | | Chicken | | and |
| | | Chicken | Heptyl | Heptyl | | Meat | Heptyl | Heptyl |
| | Blank | Meat | butyrate | Butyrate | Blank | Only | butyrate | Butyrate |
| Site 1 | 0 | 7 | 0 | 4 | 0 | 47 | 0 | 9 |
| Site 2 | 0 | 5 | 0 | 1 | 0 | 27 | 0 | 13 |
| Site 3 | 0 | 0 | 0 | 3 | 0 | 5 | 0 | 5 |
| Site 4 | 0 | 3 | 0 | 0 | 0 | 20 | 1 | 2 |
| Site 5 | 0 | 1 | 0 | 0 | 0 | 12 | 0 | 3 |
| Site 6 | 0 | 2 | 0 | 0 | 0 | 3 | 0 | 1 |
| Total | 0 | 18 | 0 | 8 | 0 | 114 | 1 | 33 |

TABLE 3
Comparison of trap captures of yellow jacket between traps
containing chicken meat and that containing heptyl butyrate. Victor ® Poison Free ®
Yellow Jacket & Flying Insect Traps (Woodstream, Lititz, PA, USA) were used for
this experiment. The Victor ® traps have openings on the top of the
insect-receiving chamber and insects have to move downward to enter the traps. This
is different from the Rescue ® trap (Sterling International, Inc., Spokane, WA, USA)
and the Apex trap, both of which have entry holes on the bottom of receiving
chamber. All 4 Victor ® traps shown in Table were placed together.

| | 15 min | | | | 3 hrs | | | |
|---|---|---|---|---|---|---|---|---|
| | | | | Chicken | | | | Chicken |
| | | | | Meat | | | | Meat |
| | | | | and | | | | and |
| | | Chicken | Heptyl | Heptyl | | Chicken | Heptyl | Heptyl |
| | Blank | Meat | butyrate | Butyrate | Blank | Meat | butyrate | Butyrate |
| Site 1 | 0 | 1 | 0 | 0 | 0 | 17 | 0 | 2 |
| Site 2 | 0 | 2 | 0 | 0 | 0 | 3 | 0 | 1 |
| Site 3 | 0 | 4 | 0 | 0 | 0 | 6 | 0 | 0 |
| Site 4 | 0 | 3 | 0 | 1 | 0 | 26 | 3 | 4 |
| Site 5 | 0 | 5 | 0 | 0 | 0 | 35 | 0 | 16 |
| Total | 0 | 15 | 0 | 1 | 0 | 87 | 3 | 23 |

TABLE 4
Comparison of trap captures of yellow jackets between traps
containing chicken meat and traps containing heptyl butyrate. Apex traps having an
insect-receiving chamber with openings on the bottom of the chamber that permit
insects to enter the chamber but deter insects from leaving the chamber were
used in this experiment. All 4 Apex traps were placed together.

| | 15 min | | | | 3 hrs | | | |
|---|---|---|---|---|---|---|---|---|
| | | | | Chicken | | | | Chicken |
| | | | | Meat | | | | Meat |
| | | | | and | | | | and |
| | | Chicken | Heptyl | Heptyl | | Chicken | Heptyl | Heptyl |
| | Blank | Meat | butyrate | Butyrate | Blank | Meat | butyrate | Butyrate |
| Site 1 | 0 | 0 | 0 | 0 | 0 | 4 | 1 | 1 |
| Site 2 | 0 | 1 | 0 | 0 | 0 | 15 | 1 | 1 |
| Site 3 | 0 | 2 | 0 | 0 | 0 | 12 | 0 | 2 |
| Site 4 | 0 | 0 | 0 | 0 | 0 | 0 | 0 | 1 |
| Site 5 | 0 | 0 | 0 | 0 | 0 | 17 | 1 | 3 |
| Site 6 | 0 | 0 | 0 | 0 | 0 | 10 | 0 | 2 |
| Site 7 | 0 | 0 | 0 | 0 | 0 | 3 | 0 | 1 |
| Total | 0 | 3 | 0 | 0 | 0 | 57 | 2 | 10 |

### Example 3

### Effect of Placing Heptyl Butyrate Within or Outside of Traps Containing Chicken Meat

When each trap was placed separately, we found that traps containing chicken meat only did not capture many yellowjackets. This indicated that without heptyl butyrate to attract yellowjackets, chicken meat was effective in attracting yellowjackets to the trap. However, if heptyl butyrate was released immediately outside the trap that contained chicken meat, then a large number of yellowjackets were captured. This is because heptyl butyrate attracted yellowjackets to the trap and then chicken meat induced yellowjackets to enter the trap. However, if the heptyl butyrate was placed inside the trap, observations demonstrated that it did attract yellowjackets to the trap but deterred them from entering the trap. In comparison, the chicken meat flavor does not deter yellowjackets from entering the trap. These findings indicate a strong synergistic effect of the two types of attractants: one (heptyl butyrate) attracted insects from a long distance to near the trap while another non-repellent attractant induced the yellow jackets to enter the trap. This mechanism should work similarly with other insect bait stations where we would have an attractant to attract insects near the station and then another non-repellent attractant to induce the insect into the station to feed on the bait.

TABLE 5
Effects of location of yellow jacket attractant heptyl butyrate on
trap capture of yellow jackets. Traps contained either chicken meat or heptyl butyrate
or both chicken meat and heptyl butyrate. When both chicken meat and heptyl
butyrate were used, chicken meat was placed inside the trap while heptyl butyrate
was placed either inside or outside of the trap. Apex traps having an insect-receiving
chamber with openings on the bottom of the chamber that permit insects to enter the
chamber but deter insects from leaving the chamber were used in this experiment.
Within each testing site, each trap was placed separately with minimum 20 feet
between two traps. Two test sites were separated at least by 300 feet.

| | 15 min | | | | 3 hrs | | | |
|---|---|---|---|---|---|---|---|---|
| | | | | Chicken | | | | Chicken |
| | | | Chicken | Meat | | | Chicken | Meat |
| | | | Meat | and | | | Meat | and |
| | Chicken | Heptyl | and HB | HB | Chicken | Heptyl | and HB | HB |
| | Meat | butyrate | Inside | outside | Meat | butyrate | Inside | outside |
| Site 1 | 0 | 0 | 1 | 0 | 0 | 0 | 2 | 45 |
| Site 2 | 0 | 0 | 0 | 0 | 2 | 0 | 0 | 19 |
| Site 3 | 0 | 0 | 0 | 2 | 0 | 0 | 5 | 16 |
| Site 4 | 0 | 0 | 0 | 2 | 3 | 2 | 1 | 17 |
| Site 5 | 1 | 0 | 1 | 0 | 2 | 0 | 1 | 4 |
| Site 6 | 0 | 0 | 0 | 1 | 0 | 0 | 0 | 12 |
| Total | 1 | 0 | 2 | 5 | 7 | 2 | 9 | 113 |

### Example 4

### Similar Results are Obtained with Other Types of Meat Baits when Combined with Heptyl Butyrate Inside a Trap

In independent experiments, both pork meat and beef flavor were found to have an inhibitory effect at a 3 hour time point when combined with heptyl butyrate inside a trap.

TABLE 6
Comparison of trap captures of yellow jacket between traps
containing pork meat alone and traps containing heptyl butyrate either alone or
inside the trap with the pork meat. Apex traps having an insect-receiving chamber
with openings on the bottom of the chamber that permit insects to enter the chamber
but deter insects from leaving the chamber were used in this experiment. All 4
traps were placed together. Sites 7-9 were conducted in different day and the
final reading were taken at 5 hours after trap placement.

| | 15 min | | | | 3 hrs or 5 hrs¹ | | | |
|---|---|---|---|---|---|---|---|---|
| | | | | Pork | | | | Pork |
| | | | | Meat | | | | Meat |
| | | | | and | | | | and |
| | | | Heptyl | Heptyl | | | Heptyl | Heptyl |
| | Blank | Pork Meat | butyrate | Butyrate | Blank | Pork Meat | butyrate | Butyrate |
| Site 1 | 0 | 0 | 0 | 0 | 0 | 6 | 0 | 0 |
| Site 2 | 0 | 0 | 0 | 0 | 0 | 5 | 0 | 2 |
| Site 3 | 0 | 0 | 0 | 0 | 0 | 0 | 1 | 0 |
| Site 4 | 0 | 0 | 0 | 0 | 0 | 3 | 0 | 1 |
| Site 5 | 0 | 0 | 0 | 0 | 0 | 8 | 0 | 2 |
| Site 6 | 0 | 2 | 0 | 0 | 0 | 16 | 1 | 5 |
| Site 7 | 0 | 2 | 0 | 4 | 0 | 20 | 0 | 13 |
| Site 8 | 0 | 5 | 0 | 5 | 0 | 35 | 0 | 18 |
| Site 9 | 0 | 0 | 0 | 0 | 0 | 5 | 0 | 0 |
| Total | 0 | 9 | 0 | 9 | 0 | 98 | 2 | 41 |

Sites 1-3 were read after 5 hours

TABLE 7
Comparison of trap capture of yellow jackets between traps
containing meat flavor and traps containing heptyl butyrate. Apex traps having an
insect-receiving chamber with openings on the bottom of the chamber that permit
insects to enter the chamber but deter insects from leaving the chamber were used
in this experiment. All 4 traps were placed together. Sites 1-3 were conducted on
different days and the final readings were taken at 3 or 5 hours after trap placement.

| | 15 min | | | | 3 hrs or 5 hrs | | | |
|---|---|---|---|---|---|---|---|---|
| | | | | Beef | | | | Beef |
| | | | | Flavor | | | | Flavor |
| | | | | and | | | | and |
| | | Beef | Heptyl | Heptyl | | Beef | Heptyl | Heptyl |
| | Blank | Flavor | butyrate | Butyrate | Blank | Flavor | butyrate | Butyrate |
| Site 1 | 0 | 1 | 0 | 0 | 0 | 3 | 0 | 0 |
| Site 2 | 0 | 0 | 1 | 1 | 0 | 9 | 1 | 8 |
| Site 3 | 0 | 0 | 0 | 0 | 0 | 12 | 1 | 3 |
| Site 4 | 0 | 0 | 0 | 0 | 0 | 7 | 1 | 3 |
| Site 5 | 0 | 0 | 0 | 0 | 0 | 8 | 0 | 13 |
| Site 6 | 0 | 0 | 0 | 0 | 0 | 18 | 2 | 4 |
| Total | 0 | 1 | 1 | 1 | 0 | 57 | 5 | 31 |

### CITED REFERENCES

Davis, H. G., G. W. Eddy, T. P. McGovern, and M. Beroza. 1967. 2,4-Hexadienyl butyrate and related compounds highly attractive to yellowjackets (Vespula spp.). J. Med. Entomol. 4: 29-34.

Davis, H. G., G. W. Eddy, T. P. McGovern, and M. Beroza. 1969. Heptyl butyrate, a new synthetic attractant for yellowjackets. J. Econ. Entomol. 62: 1245.

Davis, H. G., R. J. Peterson, W. M. Rogoff, T. P. McGovern, and M. Beroza. 1972. Octyl butyrate, an effective attractant for the yellowjacket. Environ. Entomol. 1: 673.

Davis, H. G., R. W. Zwick, W. M. Rogoff, T. P. McGovern, and M. Beroza. 1973. Perimeter traps baited with synthetic lures for suppression of yellowjackets in fruit orchards. Environ. Entomol. 2: 570-571.

Landolt, P. J. 1998. Chemical attractants for trapping yellow jackets Vespula germanica and Vespula pensylvanica (Hymenoptera: Vespidae). Environ. Entomol. 27(5): 1229-1234 (1998).

Landolt, P. J., A. Pantoja and D. Green 2005. Yellowjacket wasps (Hymenoptera: Vespidae) trapped in Alaska with heptyl butyrate, acetic acid and isobutanol. J. Entomol. Soc. Brit. Columbia 102: 35-41.

Landolt, P. J., Reed, H. C., and D. J. Ellis. 2003. Trapping yellowjackets (Hymenoptera: Vespidae) with heptyl butyrate emitted from controlled-release dispensers. Florida Entomol. 26(3): 323-328.

MacDonald, J. F., R. D. Akre, and W. B. Hill. 1973. Attraction of yellowjackets (Vespula spp.) to heptyl butyrate in Washington State (Hymenoptera: Vespidae). Environ. Entomol. 2: 375-379.

McGovern, T. P., H. G. Davis, M. Beroza, J. C. Ingangi, and G. W. Eddy. 1970. Esters highly attractive to Vespula spp. J. Econ. Entomol. 63:1534-1536.

Spurr, E. B., K. W. Drew, P. E. C. Read, and G. Elliott. 1996. The effectiveness of a sulfluramid concentrate mixed with canned sardine cat-food for control of wasps. Proceedings, 49th New Zealand Plant Protection Conference 1996: 132-136. New Zealand Plant Protection Society, Rotorua, New Zealand.

The breadth and scope of the present disclosure should not be limited by any of the above-described exemplary embodiments, but should be defined only in accordance with the following claims and their equivalents.

What is claimed is:

1. A insect attracting station comprising:
a housing at least in part defining an insect-receiving chamber, the housing being adapted and configured to permit ingress of insects into the insect-receiving chamber;
a first attractant, positioned external to the insect-receiving chamber, the first attractant being adapted to lure insects toward the insect-receiving chamber;
a second attractant, the housing and the second attractant being adapted and configured such that the second attractant emits an odor from the insect-receiving chamber to lure insects from outside of the insect-receiving chamber to within the insect-receiving chamber, the second attractant being different from the first attractant.

2. An insect attracting station as set forth in claim 1 wherein the first attractant is adapted to lure insects from a region remote from the insect-receiving chamber to a region adjacent the housing.

3. An insect attracting station as set forth in claim 1 wherein the housing at least in part defines a second chamber distinct from the insect-receiving chamber, the housing and the first attractant are adapted and configured such that the first attractant emits an odor from the second chamber.

4. An insect attracting station as set forth in claim 1 wherein the station has a higher rate of insect ingress into the insect-receiving chamber than if both the first and second attractants emitted odors from the insect-receiving chamber.

5. An insect attracting station as set forth in claim 1 wherein the housing is adapted to deter egress of insects from the insect-receiving chamber.

6. An insect attracting station as set forth in claim 1 wherein the housing is adapted to trap insects in the insect-receiving chamber.

7. An insect attracting station as set forth in claim 1 wherein the first attractant is adjacent to an exterior surface of the housing.

8. An insect attracting station as set forth in any one of claims 1-7 wherein each of the first and second attractants is adapted to lure at least one insect species from the Orders Diptera, Hymenoptera, Coleoptera, or Lepidoptera.

9. An insect attracting station of claim 1-7 wherein each of the first and second attractants is adapted to lure at least one of a yellow jacket, hornet, or wasp.

10. An insect attracting station of claim 9 wherein:
the first attractant comprises at least one component selected from the group consisting of heptyl butryrate, butyl butryrate, isobutanol, 2-methyl butanol, and 3-methyl butanol, and
the second attractant comprises at least one component selected from the group consisting of acetic acid, fish, fish essence, a fish constituent, a fish decomposition product, meat, meat essence, a meat constituent, a meat decomposition product, and a meat extract.

11. An insect attracting station of claim 1-7 wherein each of the first and second attractants is adapted to lure wasp species in the genus Vespula.

12. An insect attracting station as set forth in claim 1 wherein each of the first and second attractants, alone or in combination, are unable to attract mosquitoes.

13. An insect attracting station as set forth in claim 1 wherein the station is adapted to destroy insects.

14. An insect attracting station as set forth in claim 1 wherein the station is adapted to destroy insects within the insect-receiving station.

15. An insect attracting station as set forth in claim 1 further comprising an insecticide located on or within the insect-receiving chamber, wherein the insecticide is configured and adapted to be contacted and transported away from the insect attracting station via insects attracted into the insect-receiving chamber.

16. An insect attracting station as set forth in claim 1 wherein an insecticide is located on or within the insect-receiving chamber.

17. A method of attracting insects into an insect-receiving chamber of a housing of an insect-attracting station, the method comprising:
causing a first attractant to emit an odor from the insect-attracting station, the first attractant being adapted to lure insects toward the insect-receiving chamber;
causing a second attractant to emit an odor from the insect-receiving chamber to lure insects from outside of the insect-receiving chamber to within the insect-receiving chamber.

18. A method as set forth in claim 17 wherein the first attractant is adapted to lure insects from a region remote from the insect-receiving chamber to a region adjacent the housing.

19. A method as set forth in claim 18 further comprising placing the insect-attracting station in an environment having insects of the type attracted by the first and second attractants.

20. A method as set forth in claim 18 wherein the environment is outdoors.

21. A method as set forth in claim 18 wherein the station has a higher rate of insect ingress into the insect-receiving chamber than if both the first and second attractants emitted odor from the insect-receiving chamber.

22. A method as set forth in any one of claims 18-21 wherein each of the first and second attractants is adapted to lure at least one insect from the Orders Diptera, Hymenoptera, Coleoptera, or Lepidoptera within the insect-receiving chamber.

23. A method as set forth in any one of claims 18-21 wherein each of the first and second attractants is adapted to lure at least one of a yellow jacket, hornet, or wasp.

24. A method as set forth in claim 23, wherein the first attractant comprises at least one component selected from the group consisting of heptyl butryrate, butyl butryrate, isobutanol, 2-methyl butanol, and 3-methyl butanol, and wherein the second attractant comprises at least one component selected from the group consisting of acetic acid, fish, fish essence, a fish constituent, a fish decomposition product, meat, meat essence, a meat constituent, a meat decomposition product, and a meat extract.

25. A method as set forth in any one of claims 18-21, wherein each of the first and second attractants is adapted to lure a wasp species in the genus Vespula.

26. A method as set forth in claim 25, wherein the first attractant comprises at least one component selected from the group consisting of heptyl butryrate, butyl butryrate, isobutanol, 2-methyl butanol, and 3-methyl butanol and wherein the second attractant comprises at least one component selected from the group consisting of acetic acid, fish, fish essence, a fish constituent, a fish decomposition product, meat, meat essence, a meat constituent, a meat decomposition product, and a meat extract.

27. A method of inducing a user to attract insects into an insect-receiving chamber of a housing of an insect-attracting station, the method comprising inducing a user to:
cause a first attractant to emit an odor from the insect-attracting station, the first attractant being adapted to lure insects toward the insect-receiving chamber;
cause a second attractant to emit an odor from the insect-receiving chamber to lure insects from outside of the insect-receiving chamber to within the insect-receiving chamber.

28. A method as set forth in claim 27 wherein the first attractant is adapted to lure insects from a region remote from the insect-receiving chamber to a region adjacent the housing.

29. A method as set forth in claim 28 wherein the method further comprises inducing a user to place the insect-attracting station in an environment having insects of the type attracted by the first and second attractants.

30. A method as set forth in claim 28 wherein the station has a higher rate of insect ingress into the insect-receiving chamber than if both the first and second attractants emitted odors from the insect-receiving chamber.

31. A method as set forth in any one of claims 28-30 wherein each of the first and second attractants is adapted to lure at least one insect species from the Orders Diptera, Hymenoptera, Coleoptera, or Lepidoptera within the insect-receiving chamber.

32. A method as set forth in any one of claims 28-30 wherein each of the first and second attractants is adapted to lure at least one of yellow jacket, hornet, or wasp.

33. A method as set forth in claim 32 wherein the first attractant comprises at least one component selected from the group consisting of heptyl butryrate, butyl butryrate, isobutanol, 2-methyl butanol, and 3-methyl butanol, and wherein the second attractant comprises at least one component selected from the group consisting of acetic acid, fish, fish essence, a fish constituent, a fish decomposition product, meat, meat essence, a meat constituent, a meat decomposition product, and a meat extract.

34. A method as set forth in any one of claims 28-30 wherein each of the first and second attractants is adapted to lure a wasp species in the genus Vespula.

35. A method as set forth in claim 34 wherein the first attractant comprises at least one component selected from the group consisting of heptyl butryrate, butyl butryrate, isobutanol, 2-methyl butanol, and 3-methyl butanol, and a meat extract and wherein the second attractant comprises at least one component selected from the group consisting of acetic acid, fish, fish essence, a fish constituent, a fish decomposition product, meat, meat essence, a meat constituent, a meat decomposition product.

36. A method of attracting insects into an insect-receiving chamber of a housing of an insect-attracting station, the method comprising:
causing a first attractant to emit an odor, the first attractant being adapted and positioned to lure insects toward the insect-receiving chamber;
causing a second attractant to emit an odor from the insect-receiving chamber to lure insects from outside of the insect-receiving chamber to within the insect-receiving chamber.

37. A method as set forth in claim 36 wherein the station has a higher rate of insect ingress into the insect-receiving chamber than if both the first and second attractants emitted odors from the insect-receiving chamber.

38. A method as set forth in claim 37 wherein the first attractant is adapted to lure insects from a region remote from the insect-receiving chamber to a region adjacent the housing.

39. A method as set forth in claim 37 further comprising placing the insect-attracting station in an environment having insects of the type attracted by the first and second attractants.

40. A method as set forth in claim 38 wherein the environment is outdoors.

41. A method as set forth in claim 38 wherein the station has a higher rate of insect ingress into the insect-receiving chamber than if both the first and second attractants emitted odor from the insect-receiving chamber.

42. A method as set forth in any one of claims 38-41 wherein each of the first and second attractants is adapted to lure at least one insect from the Orders Diptera, Hymenoptera, Coleoptera, or Lepidoptera within the insect-receiving chamber.

43. A method as set forth in any one of claims 38-41 wherein each of the first and second attractants is adapted to lure at least one of a yellow jacket, hornet, or wasp.

44. A method as set forth in claim 43, wherein the first attractant comprises at least one component selected from the group consisting of heptyl butryrate, butyl butryrate, isobutanol, 2-methyl butanol, and 3-methyl butanol, and wherein the second attractant comprises at least one component selected from the group consisting of acetic acid, fish, fish essence, a fish constituent, a fish decomposition product, meat, meat essence, a meat constituent, a meat decomposition product, and a meat extract.

45. A method as set forth in any one of claims 38-41, wherein each of the first and second attractants is adapted to lure a wasp species in the genus Vespula.

46. A method as set forth in claim 45, wherein the first attractant comprises at least one component selected from the group consisting of heptyl butryrate, butyl butryrate, isobutanol, 2-methyl butanol, and 3-methyl butanol and wherein the second attractant comprises at least one component selected from the group consisting of acetic acid, fish, fish essence, a fish constituent, a fish decomposition product, meat, meat essence, a meat constituent, a meat decomposition product, and a meat extract.
